(19) United States
(12) Patent Application Publication
(10) Pub. No.: US 2014/0340186 A1
(43) Pub. Date: Nov. 20, 2014

(54) INTERLEAVED PLANAR INDUCTIVE DEVICE AND METHODS OF MANUFACTURE AND USE

(71) Applicant: Pulse Electronics, Inc., San Diego, CA (US)

(72) Inventors: Wang Xianfeng, Zhuhai City (CN); Ma Hongzhong, Zhuhai City (CN)

(21) Appl. No.: 14/243,786

(22) Filed: Apr. 2, 2014

Related U.S. Application Data
(60) Provisional application No. 61/810,654, filed on Apr. 10, 2013.

(51) Int. Cl. H01F 27/28; H01F 27/30; H01F 41/10; H01F 27/29

(52) U.S. Cl. CPC H01F 27/28; H01F 27/29; H01F 27/306; H01F 41/10
USPC 336/180; 336/192; 29/605

(57) ABSTRACT

A low cost, high performance electronic device for use in electronic circuits and methods. In one exemplary embodiment, the device includes an interleaved flat coil arrangement that ensures low leakage inductance while using a smaller number of flat coil windings compared to prior art devices. The flat coil windings further include features that are configured to mate with the header assembly terminal pins which substantially simplify the manufacturing process. Methods for manufacturing the device are also disclosed.

### PRIORITY

This application claims the benefit of priority to co-owned U.S. Provisional Patent Application Ser. No. 61/810,654 of the same title filed Apr. 10, 2013, the contents of which are incorporated herein by reference in their entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Technological Field

The present disclosure relates generally to circuit elements, and more particularly in one exemplary aspect to inductive devices for use in e.g., power transformers or other applications, and methods of utilizing and manufacturing the same.

2. Description of Related Technology

A myriad of different configurations of inductive electronic devices are known in the prior art. Many traditional inductive components, such as transformers, utilize primary and secondary windings made from conductors which are insulated from one another. The voltage applied to the primary winding dictates the voltage generated in the secondary winding based on the wire turn ratio between the primary and secondary windings.

However, due to inter alia, ever-increasing needs for reductions in component size and cost of manufacturing, so-called planar inductive devices that utilize printed circuit board (PCB) technology have become popular design implementations for forming inductive devices such as transformers.

One such example of a prior art flat coil planar transformer is illustrated in FIGS. 1A and 1B. The flat coil planar transformer 100 of FIGS. 1A and 1B is typically used in power supply applications or other circuits that require current isolation. The flat coil planar transformer of FIGS. 1A and 1B comprises a plurality of wound flat coils 106 that are disposed directly within a planar core formed of lower 104 and upper core elements 102. The flat coil windings are stacked in a co-axial (e.g. vertical) alignment forming an alternating primary-secondary coil arrangement, one atop the other. The flat coils are also configured to contain terminal apertures that are formed to mate to corresponding post pins resident on the header assembly 108. The core elements are formed from a magnetically permeable material, such as ferrite, with the flat coil windings sandwiched there between.

While the device in FIGS. 1A and 1B has been recognized by the industry as adequate in performing its respective mechanical and electrical functions, the device in FIGS. 1A and 1B is relatively expensive to manufacture, due at least in part to the number of flat coil windings required (e.g., six (6)) for adequate interleaving, in order to reduce the leakage inductance for the device. As is well known, leakage inductance is a property of an electrical transformer in which the windings appear to have some inductance in series with the mutually-coupled transformer windings. This is due in part to imperfect coupling of the windings within the transformer.

The stacked arrangement shown in FIGS. 1A and 1B also exhibits disadvantageously high capacitive coupling between the windings. This capacitive coupling between the coils introduces phase-shift and amplitude errors during the coupling process.

In order to address, inter alia, the leakage inductance of the transformer, six (6) or more flat coils are needed in the designs of the prior art inductive device, resulting in increased material and manufacturing processes. In addition to the resultant increased material and labor costs, the use of extra material and manufacturing processes results in increased size and manufacturing complexity for the device.

Accordingly, there remains a salient need for inductive devices that are less costly and easier to manufacture, have lower leakage inductance and lower capacitive coupling, such new devices being enabled by, inter alia, addressing the difficulties associated with the stacking of the flat coil windings as is known in the prior art.

### SUMMARY

In a first aspect, an inductive device is disclosed. In one embodiment, the device includes: a header assembly comprising a plurality of terminals; at least one core; and an interleaved flat coil winding arrangement comprising two or more flat coil windings, disposed in proximity to the at least one core and electrically coupled with respective ones of the terminals.

In another embodiment, the inductive device comprises a spatially compact “deeply interleaved” inductive device (e.g., transformer, inductive reactor, etc.).

In a second aspect, a header is disclosed. In one embodiment, the header includes a reduced number of terminal pins for use with the aforementioned inductive device.

In a third aspect, an interleaved flat coil arrangement winding for use in the aforementioned inductive device is disclosed.

In a fourth aspect, a method of manufacturing an inductive device is disclosed. In one embodiment, the aforementioned interleaved flat coil arrangement is formed by rotating a first flat coil winding clockwise within a second flat coil winding to form a bifilar winding, and then rotating a third flat coil winding within the bifilar winding to form a trifilar arrangement.

In yet another embodiment, the deep interleaved flat coil arrangement is formed by winding two or more flat wires together around a mandrel simultaneously.

In another aspect, a method of operating an inductive device is disclosed. In one embodiment, the method includes inducing a current in a first (e.g., primary) winding of an inductive device, the induced current resulting in a second current being induced within a second (e.g., secondary) winding of the device, with reduced capacitive coupling and leakage inductance.

In a further aspect, an electronic assembly including at least one inductive device is disclosed. In one embodiment, the assembly includes at least one substrate, and at least one “flat” coil inductive device of the type disclosed herein.

### BRIEF DESCRIPTION OF THE DRAWINGS

The features, objectives, and advantages of the disclosure will become more apparent from the detailed description set forth below when taken in conjunction with the drawings, wherein:

FIGS. 1A and 1B are a perspective view and an exploded perspective view of a prior art planar flat coil transformer.

FIG. 2 is an exploded perspective view of an inductive device in accordance with one embodiment of the present disclosure.

FIG. 3 is a perspective view of the header assembly illustrated in FIG. 2 in accordance with one embodiment of the present disclosure.

FIG. 4 is a perspective view of the inductive device illustrated in FIG. 2, assembled.

FIG. 5 is a flow chart diagram illustrating an exemplary method of manufacture in accordance with one embodiment of the present disclosure.

FIG. 6 is a first exemplary process flow diagram illustrating one embodiment of a method of manufacturing the deep interleaved flat coil winding arrangement in accordance with the principles of the present disclosure.

FIG. 7 is a second exemplary process flow diagram illustrating another embodiment of a method of manufacturing the deep interleaved flat coil winding arrangement in accordance with the principles of the present disclosure.

All Figures disclosed herein are © Copyright 2013 Pulse Electronics, Inc. All rights reserved.

### DETAILED DESCRIPTION

Reference is now made to the drawings wherein like numerals refer to like parts throughout.

As used herein, the terms “bobbin”, “form” (or “former”) and “winding post” are used without limitation to refer to any structure or component(s) external to the windings themselves that are disposed on or within or as part of an inductive device which helps form or maintain one or more windings of the device.

As used herein, the terms “deep interleaved” or “deeply interleaved” are used without limitation to refer to two (2) or more individual coil windings that have at least a portion of their respective windings interleaved for one (1) or more turns.

As used herein, the terms “electrical component” and “electronic component” are used interchangeably and refer to components adapted to provide some electrical and/or signal conditioning function, including without limitation inductive reactors (“choke coils”), transformers, filters, transistors, gapped core toroids, inductors (coupled or otherwise), capacitors, resistors, operational amplifiers, and diodes, whether discrete components or integrated circuits, whether alone or in combination.

As used herein, the term “inductive device” refers to any device using or implementing induction including, without limitation, inductors, transformers, and inductive reactors (or “choke coils”).

As used herein, the term “signal conditioning” or “conditioning” shall be understood to include, but not be limited to, signal voltage transformation, filtering and noise mitigation, signal splitting, impedance control and correction, current limiting, capacitance control, and time delay.

As used herein, the terms “top”, “bottom”, “side”, “up”, “down” and the like merely connote a relative position or geometry of one component to another, and in no way connote an absolute frame of reference or any required orientation. For example, a “top” portion of a component may actually reside below a “bottom” portion when the component is mounted to another device (e.g., to the underside of a PCB).

### Overview

The present disclosure provides, inter alia, an improved low cost inductive device, and methods for manufacturing and utilizing the same. Embodiments of the improved inductive device described herein are adapted to overcome the disabilities of the prior art, such as by providing a “deep” interleaved flat coil winding arrangement that eliminates the stacked vertical arrangement found in the prior art. Specifically, embodiments of the present disclosure use wound flat coils that have interleaving which reduces the leakage inductance of the inductive device, while decreasing the manufacturing cost (by up to 20%) by, inter alia, requiring a lower number of flat coil windings and terminal pins. Advantageously, the exemplary deep interleaved arrangement also provides for reduced coupling capacitance between the coils as well as a reduced overall height as compared with prior art inductive devices.

Exemplary embodiments of the device are also adapted for ready use by automated packaging equipment such as e.g., pick-and-place equipment and other similar automated manufacturing devices.

Embodiments of the disclosure also advantageously provide a high level of consistency and reliability of performance by limiting opportunities for errors or other imperfections during the manufacture of the device.

Inductive devices of the present disclosure are also suitable for use in, inter alia, DC to DC forward/half-bridge and full-bridge topologies.

### DETAILED DESCRIPTION OF EXEMPLARY EMBODIMENTS

Detailed descriptions of the various embodiments and variants of the apparatus and methods of the disclosure are now provided. While primarily discussed in the context of inductive devices used in e.g., power transformer applications, the various apparatus and methodologies discussed herein are not so limited. In fact, many of the apparatus and methodologies described herein are useful in any number of electronic or signal conditioning components that can benefit from the simplified manufacturing methodologies described herein.

In addition, it is further appreciated that certain features discussed with respect to specific embodiments can, in many instances, be readily adapted for use in one or more other contemplated embodiments that are described herein. It would be readily recognized by one of ordinary skill, given the present disclosure, that many of the features described herein possess broader utility outside of the specific examples and implementations and combinations with which they are described.

### Inductive Device

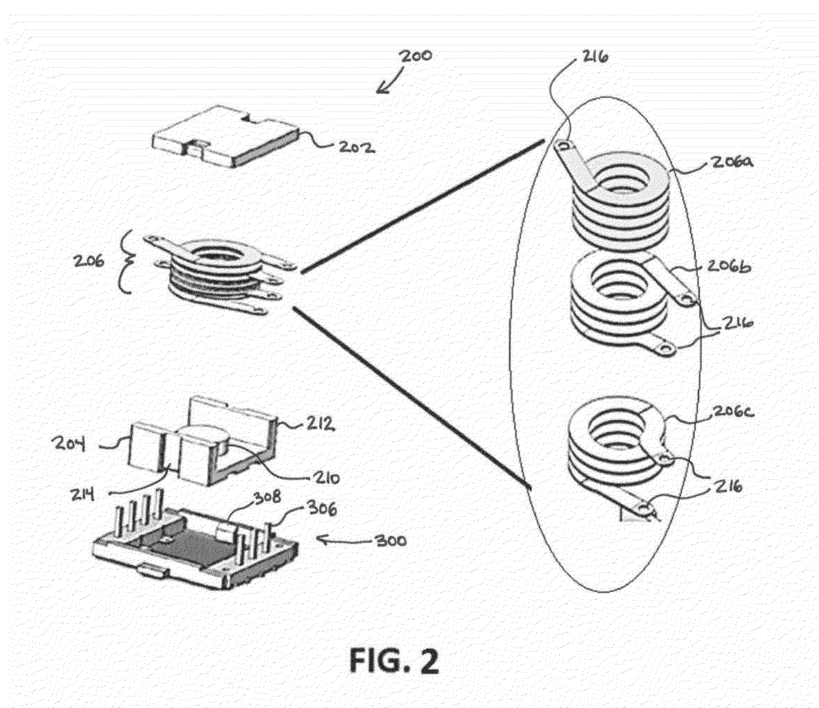

Referring now to FIG. 2, a first exemplary embodiment of an inductive device 200 in accordance with the principles of the present disclosure is shown and described in detail. The inductive device as illustrated includes an upper core element 202 and a lower core element 204, a deep interleaved flat coil arrangement 206, and a header assembly 208. The deep interleaved flat coil arrangement 206 is preferably formed prior to being received on the center post 210 of the lower core element 204, although such formation “around” the post is also contemplated herein.

It will be appreciated that as used herein, the term “flat” includes windings and other components which have at least one substantially planar side, and the term in no way connotes any particular thickness or height.

The lower core element 204 as illustrated includes a flat bottom surface, while the opposing interior surface includes two riser elements 212 and a cylindrical center post element 210 that protrudes from the geometric center of the lower core element. The riser elements in this embodiment are located at opposing edges and run the entire width of the lower core element. The center post element is configured to have the same height as the riser elements; however it is also envisioned that in certain embodiments, it may be desirable to include a reduced height for the center post thereby creating a gap that allows for adjustment of the inductive characteristics of the inductive device, as is known in the inductive/electronic arts. The lower core element also, in the illustrated embodiment, includes alignment features 214 that are configured to mate with respective standoff elements 308 present on the header assembly. The upper core element 202, in the illustrated embodiment, is configured with flat external surfaces. The length and width dimensions of the upper core element are sized so as to generally match the respective dimensions of the lower core element.

While a specific exemplary core configuration is illustrated in FIG. 2, it is appreciated that the present disclosure described herein is not so limited. For example, the upper and lower core element configurations could be swapped such that the lower core element is now the upper core (i.e., that away from the host device or substrate to which the device is to be mounted), while the upper core element becomes the lower core. In addition, while a cylindrical center post element 210 is illustrated as exemplary, it is appreciated that this center post element can shaped to accommodate any number of differing configurations. For example, the center post can comprise an elongated cylindrical post such as those described in co-owned U.S. Provisional Patent Application Ser. No. 61/650,395 filed May 22, 2012 and entitled “Substrate-Based Inductive Devices and Methods of Using and Manufacturing the Same”, the contents of which are incorporated herein by reference in its entirety, could also be readily substituted in alternative embodiments. An elliptical, square, polygonal, or other shape can also be used if desired. Additionally, further core configurations, such as those described in co-owned U.S. Pat. No. 7,994,891 filed Oct. 1, 2009 and entitled “Stacked Inductive Device Assemblies and Methods”, the contents of which are incorporated herein by reference in its entirety, could also be readily substituted in alternative embodiments.

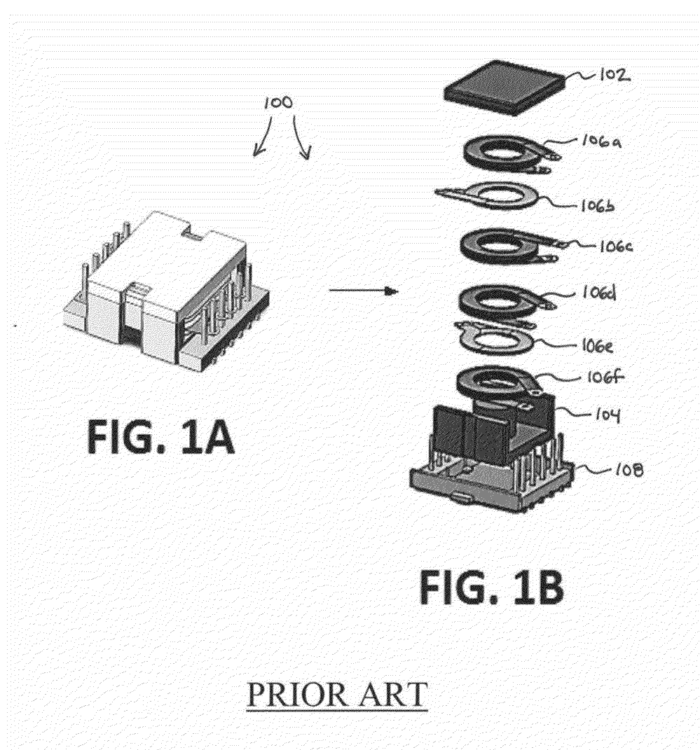

The inductive device 200, as discussed previously herein, further includes a deep interleaved flat coil arrangement 206 comprising three (3) flat coil windings 206(a), 206(b), and 206(c). While the use of three (3) flat coil windings is exemplary, it is appreciated that more or less flat coil windings could readily be substituted in alternative configurations. The use of three (3) flat coil windings is merely illustrated to demonstrate the efficacy of using a deep interleaved arrangement over a similar flat coil winding as is present in the prior art device illustrated with respect to FIGS. 1A and 1B. The flat coil windings in this illustrated embodiment are formed from a metallic flat wire stock that is wound onto a mandrel, and subsequently coated with a nonconductive material (such as a polymer) to provide electrical isolation between adjacent layers when formed into a coil. Once such exemplary method for providing electrical isolation for the flat coil windings is the use of a parylene coating such as that disclosed in co-owned U.S. Pat. No. 6,642,827 issued on Nov. 4, 2003 and entitled “Advanced Electronic Microminiature Coil and Method of Manufacturing”, the contents of which are incorporated herein by reference in their entirety. When wound onto the mandrel, the flat coil windings are formed into a compressed spiral loop where the number of loops is associated with the number of turns for the inductive device. The loop diameter for the flat coil winding is also variable although, in the illustrated embodiment, chosen so as to be of a sufficient size in order to accommodate the center post of the lower core element.

The inductive device 200 of FIG. 2 includes three (3) flat coil windings with one (1) primary winding and two (2) sets of secondary windings within the deeply interleaved flat coil arrangement 206. In the embodiment illustrated in FIG. 2, the primary flat coil winding consists of five (5) turns, while the associated secondary windings only have two (2) turns a piece thus providing a turns ratio (T/R) of 5T:2T:2T. While the specific number of turns for the flat coil windings shown is exemplary, it is appreciated that the associated windings and turns ratios could be readily varied in accordance with principles of the present disclosure. In addition to varying the number of flat coil windings and the number of turns within a given winding, the size of the windings can also be varied. For example, the primary winding could have a given width (i.e., distance from inner to outer edge measured radially) and thickness associated with that primary winding, while the secondary winding might have the same thickness as the primary winding but have a differing width. Such a configuration might, for example, vary the capacitive characteristics of the underlying inductive device by varying the amount of overlap between a given primary winding and a given secondary winding.

Additionally, the thicknesses of the primary and secondary windings may vary in some embodiments, while the respective widths may either be the same or vary. By varying the thicknesses of the flat coil windings, the amount of current that a given winding can support will also vary accordingly.

The ends of the flat coil windings illustrated in FIG. 2 also include terminal apertures 216. The terminal apertures 216 are configured to accept terminal pins 306 resident within the header assembly 208. The use of these terminal apertures within the flat coil windings, in combination with the terminal pins resident on the header assembly, aids in maintaining the positioning of the deep interleaved flat coil arrangement. Accordingly, the interleaved flat coil arrangement 206 is configured to be self-aligning when installed onto the header assembly 208 of the inductive device 200, thereby obviating the need for complex assembly fixtures and assembly processes. Herein lies another salient advantage of the interleaved flat coil arrangement of the exemplary embodiments of the present disclosure. Namely, as the number of flat coil windings necessary for a given prior art design is reduced, the number of terminal pins necessary to electrically join the various coil windings is also substantially reduced. For example, in the embodiment illustrated in FIG. 2, a total of five (5) terminal pins are necessary to complete the connections for the underlying inductive device. However, the prior art inductive device illustrated in FIGS. 1A and 1B necessitates the incorporation of nine (9) terminal pins in order to complete the connections for the inductive device. Accordingly, the bonding process between the interleaved flat coil arrangement and the header assembly is substantially simplified, as the number of flat coil winding terminations necessary for termination is reduced. Such a reduction in number allows for cost reduction, as well as reduction in the footprint size of the inductive device. Each of these terminations can be bonded to the terminals via standard soldering operations such as via solder reflow, solder dipping, hand soldering, resistance welding, etc.

The plurality of flat coil windings 206 are interleaved, unlike the stacked arrangement known in the prior art. In the illustrated embodiment, the deep interleaved arrangement has the primary and secondary flat coil windings arranged such that layers between the windings are interleaved between individual turns of the flat coil windings. The arrangement comprises closely spaced bifilar (or tri-filar windings as illustrated in FIG. 2), and thus has improved coupling between the primary and secondary windings thereby resulting in a reduced leakage inductance. The deep interleaving of the flat coil windings allows for the use of a lesser number of flat coil windings than would otherwise be necessary in a stacked coil arrangement such as that shown in FIGS. 1A and 1B. For example, and as previously described, the arrangement shown in FIG. 2 requires three (3) flat coil windings as opposed to the arrangement in FIGS. 1A and 1B which requires a total of six (6) flat coil windings. Such an arrangement has resulted in a reduction in the inductance leakage from approximately 0.103 μH exhibited in the prior art device of FIGS. 1A and 1B to approximately 0.057 μH in the embodiment of FIG. 2, a reduction of approximately forty-four percent (44%). This forty-four percent (44%) reduction in leakage inductance is primarily achieved by the deep interleaved nature of the flat coil arrangement.

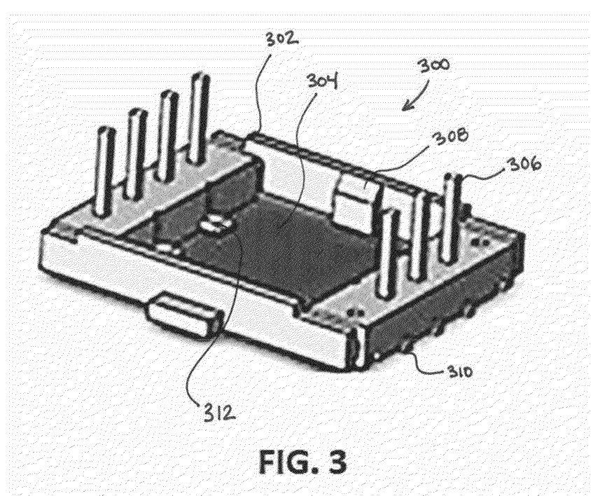

Referring now to FIG. 3, an exemplary embodiment of the header assembly 300 for use with the inductive device of FIG. 2 is shown and described in detail. The header body 302 is preferably formed from an injection molded polymer. The header body in the illustrated embodiment includes a center cavity 304 designed to accommodate the lower core element. By sizing the center cavity to a dimension slightly larger than the lower core element, the lower core element is properly positioned within the header assembly so as to facilitate the self-alignment of the interleaved flat coil arrangement with the terminal pins 306.

The terminal pins 306 are, in an exemplary embodiment, constructed from a copper-based alloy material that is useful for solder processes compliant with the restriction of hazardous substances directive (RoHS). The terminal pins are, in an exemplary embodiment, insert-molded into the header body. While insert molded terminals are exemplary, post inserting processes (i.e. after molding process) can also be readily utilized if desired. The terminals pins are also sized so as to mate with respective terminal apertures 216 present on the interleaved flat coil arrangement 206. The terminals also include, in an exemplary embodiment, a tapered end that facilitates insertion of the flat coil windings onto the terminals. The bottom of the vertical terminal pins are also formed at an approximate 90-degree angle to create a surface mount terminal 310, although other interfaces for the terminal pins, such as through hole terminals, could be readily substituted if desired. While illustrated as including gull-wing surface mount terminals, it is appreciated that alternative arrangements could also be accommodated. For example, the terminals can include spool head surface mount terminals which are configured for surface mounting the inductive device to a printed circuit board without increasing the overall footprint of the inductive device. Furthermore, it will be appreciated that the header assembly may comprise a self-leaded arrangement (not shown) of the type described in co-owned U.S. Pat. No. 5,212,345 to Gutierrez issued May 18, 1993 entitled “Self leaded surface mounted coplanar header”, or U.S. Pat. No. 5,309,130 to Lint issued May 3, 1994 and entitled “Self leaded surface mount coil lead form”, both of which are incorporated herein by reference in their entirety. These and other embodiments would be readily apparent to one of ordinary skill given the present disclosure.

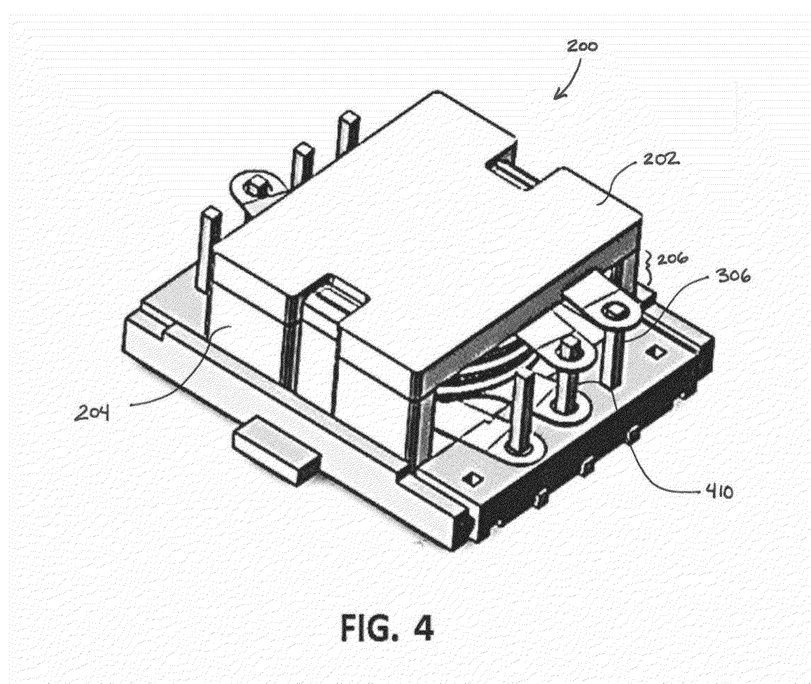

Referring now to FIG. 4, the inductive device 200 illustrated in FIG. 2 is shown in its assembled form. As discussed previously, the interleaved flat coil arrangement 206 is installed on the center post of the lower core element and aligned so that the terminal apertures 216 mate with their respective terminal pins 306 of the header assembly 208. The flat coil windings and the terminal pins are subsequently bonded using soldering or other bonding methods (e.g. resistance welding, etc.). Furthermore, as is also readily apparent in the embodiment illustrated in FIG. 4, more than one terminal connection can reside on a given terminal pin 410 in order to facilitate the inclusion of center taps. Furthermore, the terminal connections may reside at varying levels of the terminal pins. Such a configuration is advantageous as the distance between adjacent terminal connections is maximized to prevent the device's resistance to high voltage potentials that can cause, inter alia, arcing/shorting between adjacent terminal pins.

### Exemplary Inductive Device Applications

The exemplary inductive devices described herein can be utilized in any number of different operational applications. In addition to power transformers with a single primary winding and one or more secondary windings, other possible electrical applications for the inductive devices described herein include, without limitation, isolation transformers, inductors, common-mode chokes, and switch-mode power transformers used, inter alia, in power supply applications. Moreover, the exemplary inductive devices described herein are suitable for use in direct current (DC) to DC forward/half-bridge and DC to DC full-bridge topologies. These and other inductive device applications would be readily apparent to one of ordinary skill given the present disclosure.

### Methods of Manufacture

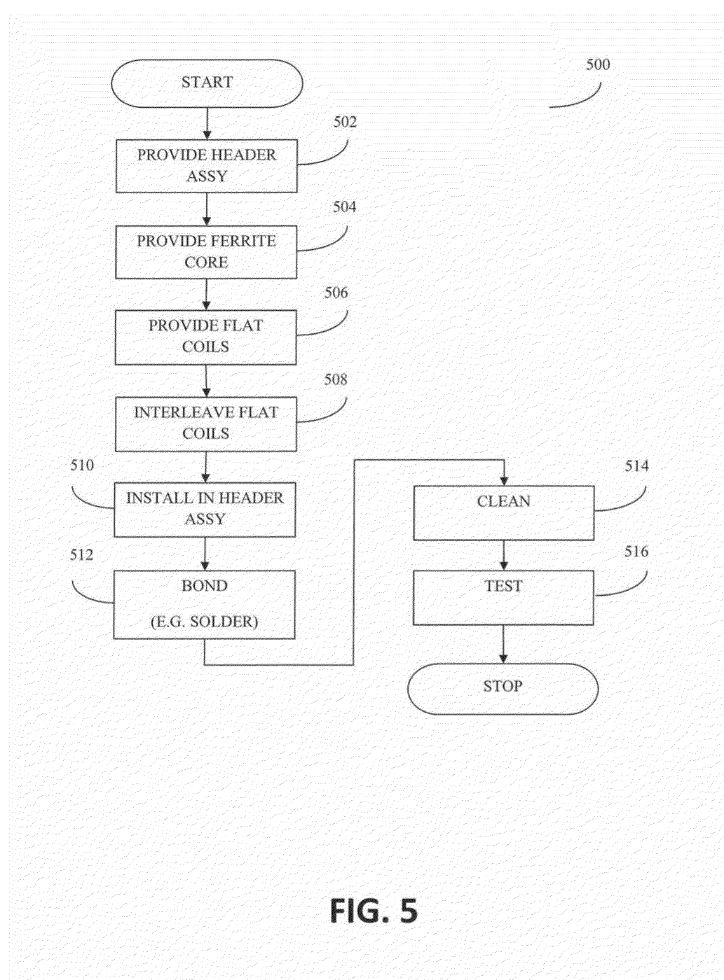

Referring now to FIG. 5, an exemplary embodiment of a method 500 for manufacturing the inductive device of, for example, FIGS. 2-4 is now described in detail. It will be recognized that while the following description is cast in terms of the inductive device 200 of FIGS. 2-4, the method is generally applicable to the various other configurations and embodiments of devices disclosed herein with proper adaptation, such adaptation being readily accomplished by one of ordinary skill when provided the present disclosure.

At step 502, a header assembly is provided. The header assemblies may be obtained by e.g., purchasing them from an external entity, or they can be indigenously fabricated by the assembler, or combinations of the foregoing. The exemplary header assembly is, as was previously discussed, manufactured using a standard injection molding process of the type well understood in the polymer arts, although other constructions and processes may be used. In addition, the header assembly will contain post pin terminals with the bottom of the pin terminals preferably formed to provide for a surface mount connection, although other types of surface mount or other mounting approaches may be used (e.g., through-hole terminals, etc.).

At step 504, one or more core elements are provided. The upper core elements described herein may be, e.g., obtained by purchase from an external entity, or alternatively, fabricated in-house. Lower core elements are also obtained by purchase from an external entity or fabricated. The core components of the exemplary inductive device described above is, in an exemplary embodiment, formed from a magnetically permeable material (e.g., so-called “soft” iron, laminated silicon steel, carbonyl iron, iron powders and/or ferrite ceramics) using any number of well understood manufacturing processes such as pressing or sintering. Exemplary embodiments of the core elements described herein are produced to have various material-dependent magnetic flux properties, cross-sectional shapes, riser dimensions, gaps, etc.

At step 506, the flat coil windings are provided. In one embodiment, the flat coil windings are formed onto a mandrel, and subsequently insulated using well known processes such as parylene coating vapor deposition. The flat coils can either be formed individually or in the alternative formed with multiple flat coils formed simultaneously. The flat coils are preferably formed from a copper-based alloy flat wire; although other types of conductive materials such as nickel-iron alloys (e.g., Alloy 42) may be readily substituted. After forming, the terminal apertures, intended to mate with their respective post pins on the header assembly, and optional notches are stamped into the flat coil windings. Alternatively, the terminal apertures and notches are stamped into the flat coil windings prior to being disposed and formed onto a mandrel.

At step 508, the flat coils are arranged into the desired deep interleaved flat coil arrangement using the methods described herein. In one embodiment, the deep interleaved flat coil arrangement is placed onto the lower core element such that the center core element of the lower core element is received within the center opening of the flat coil windings. The upper core element is then disposed onto the lower core element and mated thereto. The upper core element and lower core element are then secured to one another via an epoxy adhesive, or via mechanical means such as an external clip, etc.

At step 510, the assembled core and deep interleaved flat coil assembly are placed onto the header assembly. In one embodiment, the interleaved flat coil assembly is placed within the interior cavity of the header assembly such that the assembly is resting upon the internal standoff features 312 of the header assembly as shown in FIG. 3. The core assembly is then optionally secured to the header assembly using an adhesive or secured via a mechanical fit such as via a press fit or snap feature. During installation the terminal apertures of the flat coil windings are arranged such that they mate with the respective terminal pins of the header assembly.

In an alternative arrangement, the lower core is first secured to the header assembly using, for example, an epoxy adhesive. The interleaved flat coil assembly is then placed onto the bottom core and arranged such that the terminal apertures are received onto the terminals. The upper core element is then subsequently bonded to the lower core element using an epoxy adhesive. One or more of a face-to-face bond or bridge bond is then used to secure the upper and lower core elements to one another.

At step 512, the header assembly terminal pins and interleaved flat coil arrangement of the subassembly are bonded. In one embodiment, the bonding is performed using a standard eutectic solder. In an alternative embodiment, a conductive epoxy can be utilized at the terminal apertures of the flat coil windings thereby forming a mechanical and electrical connection with the terminal pins of the header assembly. In yet another alternative, the arrangement is secured to the terminal pins via a welding technique (e.g. resistance welding).

At steps 514 and 516, the headers are optionally cleaned (e.g., for 2-5 minutes in either de-ionized water or isopropyl alcohol or another solvent), such as by using an ultrasonic cleaning machine in order to remove chemicals and contaminants that can, for example cause degradation of the underlying inductive device. The inductive device is then marked (including product number and manufacturing code), tested if desired and subsequently re-worked, if necessary, to correct any manufacturing defects that may be present. The inductive devices are then subsequently packaged for shipment, preferably in packaging that facilitates automated handling (e.g. tape and reel carriers and the like).

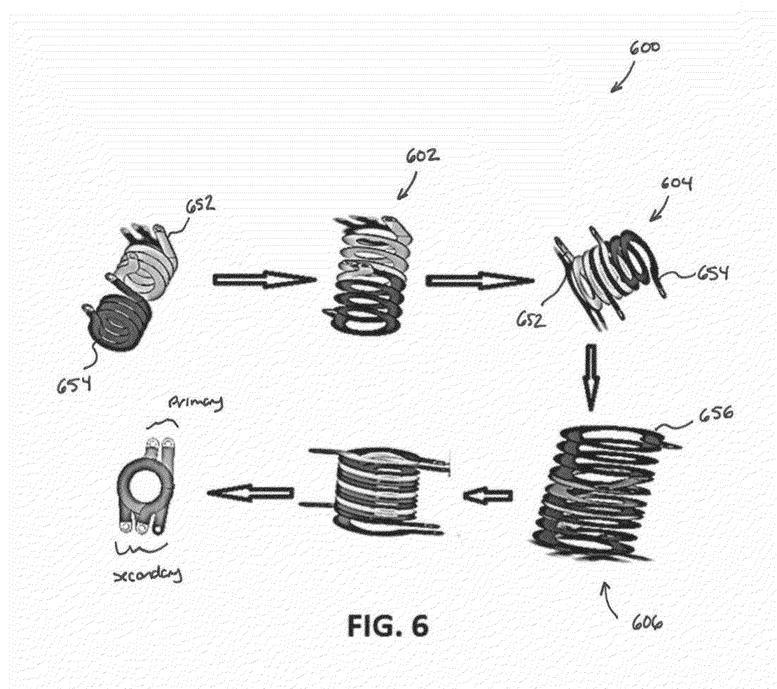

Referring now to FIG. 6, a process flow diagram is shown which illustrates one embodiment of the construction of a deep interleaved flat coil arrangement. In the embodiment of FIG. 6, it is noted that the flat coil windings 652, 654, 656 are formed prior to being arranged in their deep interleaved arrangement. At step 602, two flat coil windings are provided and are wound by rotating flat coil winding 652 in counter-clockwise rotation. As shown at step 604, the two windings 652, 654 are now in a deep interleaved arrangement, thereby forming a bifilar winding 10. The number of clockwise rotations required to form the bifilar winding can vary and can, for example, comprise a number of turns present in each of the windings 652, 654. For example, the illustrated embodiment illustrates four (4) clockwise rotations. At step 606, a third winding 656 is rotated within the turns of the bifilar winding previously formed in order to form a trifilar winding. The resultant deep interleaved arrangement is formed, such that the terminals of the primary and secondary flat coil windings, respectively, are disposed on diametrically opposite ends.

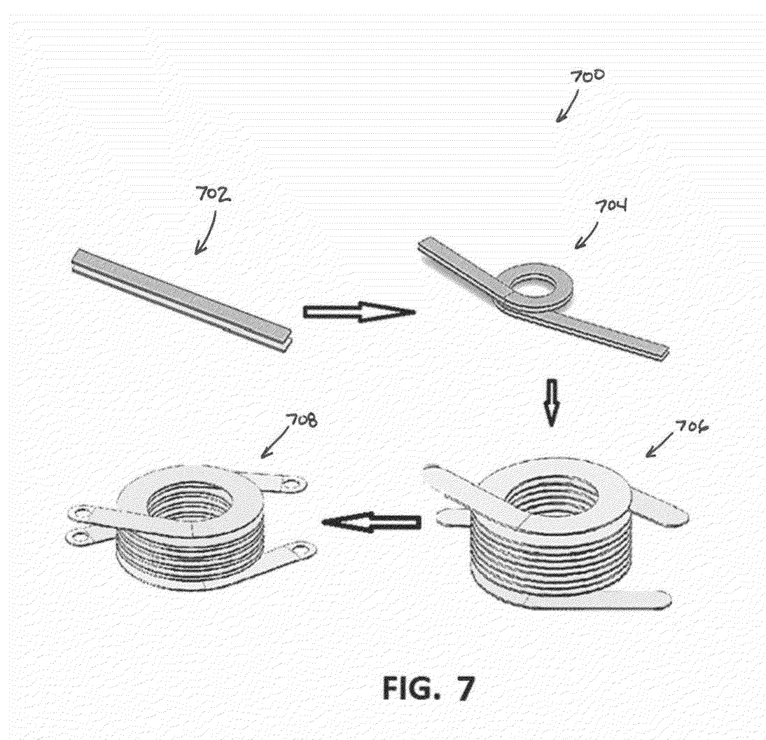

FIG. 7 shows a second exemplary method of forming the interleaved flat coil arrangement 700 is shown and described in detail. At step 702, two pieces of flat winding stock are provided.

At step 704, the two pieces of flat winding stock are wound simultaneously about a winding mandrel (not shown).

At step 706, the two pieces of flat winding stock continue to be wound in order to add additional turns to the interleaved flat coil winding. The ends of the flat winding stock are positioned such that the primary winding and the secondary winding are disposed on diametrically opposite ends.

At step 708, terminal apertures are stamped within the ends of the two interleaved flat coil windings. Alternatively, while the terminal apertures are described as being stamped subsequent to being wound into their final interleaved coil winding form, the terminal apertures can be stamped into the flat winding stock prior to being wound at step 704.

While the aforementioned method has been described with respect to two flat coil windings, it is appreciated that three or more windings can be wound into an interleaved flat coil arrangement.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

What is claimed is:

1. An inductive device, comprising:
a header assembly comprising a plurality of terminals;
at least one core; and
two or more flat coil windings arranged in an interleaved form and disposed in proximity to the at least one core and electrically coupled with respective ones of the terminals.

2. The inductive device of claim 1, wherein the two or more flat coil windings are arranged in a deeply interleaved form so as to reduce at least a leakage inductance of the inductive device as compared with a similar inductive device with two or more flat coil windings that are not in a deeply interleaved form.

3. The inductive device of claim 2, wherein the deeply interleaved form also reduces a coupling capacitance between the two or more flat coil windings.

4. The inductive device of claim 1, wherein the at least one core comprises an upper core element and a lower core element.

5. The inductive device of claim 4, wherein the two or more flat coil windings arranged in the interleaved form are foil red prior to being received on the lower core element.

6. The inductive device of claim 4, wherein the lower core element further comprises:
a flat bottom surface; and
an opposing inner surface comprising a plurality of riser elements and a center post element.

7. The inductive device of claim 6, wherein the lower core element further comprises one or more alignment features configured to mate with one or more respective features located on the header assembly.

8. The inductive device of claim 1, wherein the two or more flat coil windings comprises three flat coil windings, the three flat coil windings comprising a primary flat coil winding and two secondary flat coil windings.

9. The inductive device of claim 8, wherein the primary flat coil winding comprises five (5) turns and the two secondary flat coil windings each comprise two (2) turns thereby providing a turns ratio of 5T:2T:2T.

10. The inductive device of claim 1, wherein the two or more flat coil windings each comprise a plurality of terminal apertures, the terminal apertures configured to be received by respective ones of the plurality of terminals.

11. The inductive device of claim 10, wherein at least two of the terminal apertures are configured to be received by a single terminal of the plurality of terminals.

12. The inductive device of claim 4, wherein the header assembly comprises a center cavity that is configured to receive the lower core element.

13. The inductive device of claim 12, wherein at least a portion of the plurality of terminals each comprise a tapered end and at least a portion of the two or more flat coil windings further comprises one or more terminal apertures, the tapered end configured to be received within the one or more terminal apertures.

14. A header assembly for use with a flat coil inductive device, comprising:
a header body comprising an upper surface and a lower surface; and
a plurality of terminals, each of the terminals having a first portion that protrudes from the upper surface and a second portion that protrudes from the lower surface.

15. The header assembly of claim 14, wherein the header body further comprises a center cavity that is configured to accommodate a core element within the center cavity of the header body.

16. The header assembly of claim 15, further comprising one or more standoff features disposed within the center cavity, the one or more standoff features being configured to align a core element that is disposed within the center cavity.

17. The header assembly of claim 15, wherein the first portion of the terminals further comprises a tapered end that facilitates insertion of flat coil windings onto the terminals.

18. The header assembly of claim 17, wherein the second portion of the terminals further comprises a surface mount termination.

19. A method of manufacturing an inductive device, comprising:
providing a header assembly comprising a plurality of terminals;
providing one or more core elements;
providing a plurality of flat coil windings;
deeply interleaving the plurality of flat coil windings with respect to one another;
assembling the deeply interleaved flat coil windings and the one or more core elements within the header assembly; and
bonding the deeply interleaved flat coil windings to respective ones of the terminals so as to form the inductive device.

20. The method of claim 19, wherein the act of bonding the deeply interleaved flat coil windings further comprises bonding two or more of the plurality of flat coil windings to a single one of the plurality of terminals.
